(19) United States
(12) Patent Application Publication
(10) Pub. No.: US 2002/0165965 A1
(43) Pub. Date: Nov. 7, 2002

(54) Contention management apparatus and method

(76) Inventor: Dellas G. Frederiksen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/847,878

(22) Filed: May 2, 2001

(51) Int. Cl. G06F 15/16; G06F 15/173

(52) U.S. Cl. 709/226; 709/219; 709/201

(57) ABSTRACT

A contention management apparatus and method includes a network and more than one MFP connected to the network. A contention controller is connected to the network and through the network to the more than one MFP. The contention controller is configured to direct output from an MFP in contention to an idle MFP. In a preferred embodiment, contention controller includes a database of networked MFPs and a user priority list of MFPs for use when contention occurs.

### FIELD OF THE INVENTION

This invention generally relates to the management of contention issues among devices and, more particularly, to a contention management apparatus and method for managing contention among networked devices.

### BACKGROUND OF THE INVENTION

A variety of technologically advanced devices cooperate to provide a user in today's business world with timely and efficient service. More and more devices that serve more than one function have been adopted by users. Devices that serve more than one purpose have been termed multi-function peripherals or “MFPs”. MFPs include for example, a printer that also makes copies, sends and receives e-mails and faxes, stores information and processes incoming data. A common problem presents itself to users of MFPs, however. The problem that exists is that an MFP that is already printing a document may not print another document until the first document is finished. As a result of this “contention” problem, the user must wait until the first document is finished before receiving the second.

Currently, MFPs enable a user to scan the second document into memory while the first document is printing, but this “solution” does not appreciably increase processing speeds. Even though many offices have multiple MFPs, if a particular MFP is printing a job and the user wants to make a copy on that particular MFP, the only choice a user has is to scan the copy to be made, whereby the copy is saved for printing at a later time.

### SUMMARY OF THE INVENTION

A contention management apparatus includes a network with more than one MFP connected to the network. A contention controller is connected to the network and, through the network, to the more than one MFP. The contention controller is configured to direct output from an MFP in contention to an idle MFP. In one implementation, the contention controller further includes a database of networked MFPs and a user priority list of MFPs for use when contention occurs. In other implementations, the MFPs are connected by means of an intranet and/or the Internet.

In another implementation, a method for managing contention in MFPs includes the steps of providing a contention controller and connecting the contention controller to a network. A plurality of MFPs are also connected to the network. The contention controller is configured to identify MFPs connected to the network. Further, the contention controller is configured to identify MFPs in contention and idle MFPs. Lastly, the output of MFPs in contention is directed to idle MFPs by means of the contention controller. In a further implementation, a computer-readable medium, having computer-readable instructions, performs the steps of the method when executed by a computer.

### DESCRIPTION OF THE DRAWINGS

Other features and advantages of the present invention will become more fully apparent from the following detailed description of the preferred embodiment, the appended claims and the accompanying drawings in which:

FIG. 1 is a schematic illustration of the contention management apparatus of the present invention; and

FIG. 2 is a flow diagram of a method for managing contention in MFPs in accordance with the present invention.

### DETAILED DESCRIPTION OF THE INVENTION

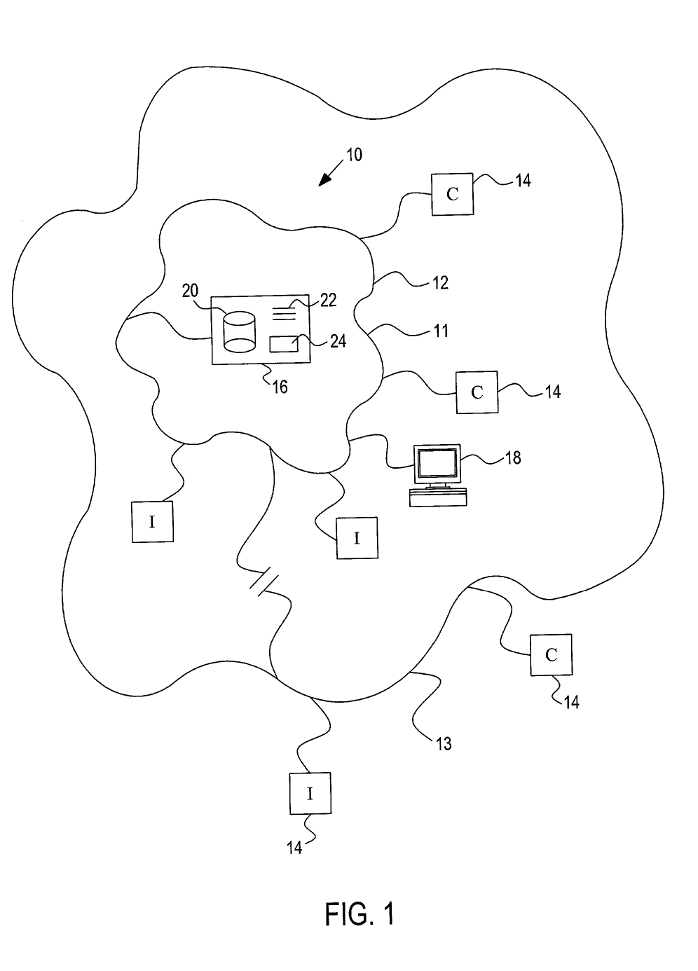

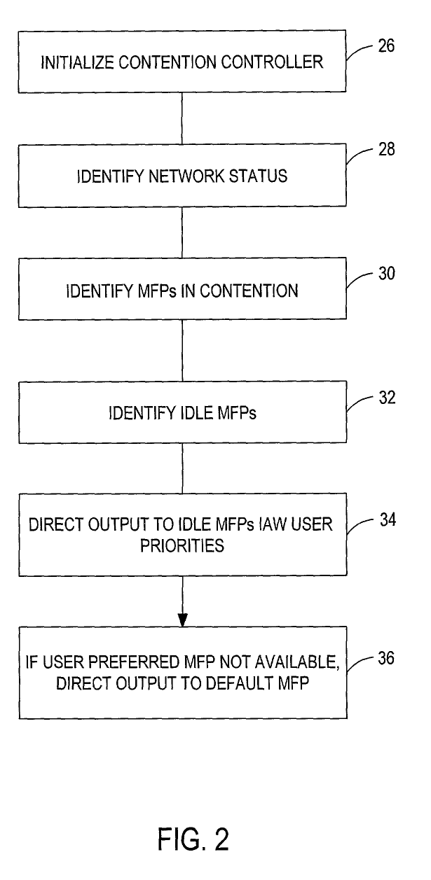

The present invention is illustrated by way of example in FIGS. 1 and 2.

With reference to FIG. 1, contention management apparatus 10 includes a network 12 and more than one MFP 14 connected to network 12. A contention controller 16 is also connected to the network 12 and, through the network 12, to the more than one MFP 14. Contention controller 16 is configured to direct output from an MFP in contention to an idle MFP. With reference to FIG. 1, for the purposes of example, the letter C is used to designate an MFP 14 in contention and the letter I is used to identify MFPs 14 that are idle. At any one time, obviously, multiple MFPs 14 may be in contention and multiple MFPs 14 may be idle. By way of network 12, contention controller 16 directs output from MFPs 14 in contention to one or more MFPs 14 that are idle.

In a preferred embodiment, contention controller 16 resides on one of the more than one MFPs 14. Likewise, in a preferred embodiment, contention controller 16 resides on and is manipulated by PC 18. PC 18 is any computer device now known or hereafter developed for use in manipulating other devices and processing information.

In a further preferred embodiment, contention controller 16 includes a database 20 of networked MFPs 14 and a user priority list 22 of MFPs 14 for use when contention occurs.

The user priority list 22 depends on the user and the particular type of job.

A user might prefer, for example, that all color jobs to go to a particular MFP 14 should contention occur.

In another implementation, network 12 is an intranet 11 or local area network, as is known in the art. In another implementation, network 12 is the Internet 13 and/or any other wide area network now known or hereafter developed. Further, any form of suitable connection to the network 12 is encompassed by the invention including wired, wireless, and the like. In another preferred embodiment, the MFPs 14 are connected by means of both intranet 11 and Internet 13.

Contention controller 16 may be hardware or software and may be an independent stand-alone device as illustrated in FIG. 1, or, as previously mentioned, it may reside on either an MFP 14 or a PC 18. Additionally, by way of example, the output of an MFP 14 in contention may be any type of output. That is, in a typical example, the output may be a document to be printed. However, the contention may involve output that may be in any form, such as audio, visual, or the like wherein the processing of the output data is held up by contention in the MFP 14.

In another implementation, contention controller 16 includes a default list 24. Default list 24 identifies MFPs 14 for use when contention occurs. Default list 24 differs from user priority list 22. User priority list 22 lists MFPs 14 that the user prefers to use in the case of contention. For example, the user may prefer in cases of contention that the work room MFP 14 be used as a first choice. The default list 24, however, lists MFPs 14 that are closest to the MFP 14 in contention, for example, and selects it in cases where priorities have not been entered or cannot be met.

Referring now to FIG. 2, in another preferred embodiment, a method for managing contention in MFPs 14 is illustrated. To begin with, in block 26 contention controller 16 is initialized. That is to say, contention controller 16 is connected to network 12 and is loaded with data concerning MFPs 14 so as to enable contention controller 16 to identify MFPs 14 that are connected to network 12. Further, contention controller 16 is configured in block 26 so as to an enable it to identify MFPs 14 in contention and idle MFPs 14.

In block 28 contention controller 16 identifies network 12 status. The status being a read out of MFPs 14 connected to the network 12. In block 30, contention controller 16 identifies MFPs 14 in contention. In block 32 contention controller 16 identifies MFPs 14 that are idle. In block 34 contention controller 16 directs the output of the MFP 14 in contention to an idle MFP 14. If user priority list 22 has been added to contention controller 16, the output is directed accordingly in block 36. If user priority list 22 has not been added or if the desired priority MFP 14 can not be accessed, contention controller 16 utilizes default list 24 to direct the output to the default MFP 14.

In a further preferred embodiment, a computer-readable medium, as now known or hereafter developed, having computer-readable instructions thereon is utilized to perform the steps of the method when executed by a computer.

User feedback is provided in a number of intuitive ways. An MFP 14 in contention may have a control panel that indicates it is in contention and inquires which idle MFPs 14 are available. Further, a user may receive such a message by e-mail on PC 18.

While the present invention has been disclosed in connection with the preferred embodiment thereof, it should be understood that there may be other embodiments which fall within the spirit and scope of the invention as defined by the following claims.

What is claimed is:

1. A contention management apparatus comprising:
(a) a network;
(b) more than one MFP connected to the network; and
(c) a contention controller connected to the network and through the network to the more than one MFP, the contention controller configured to direct output from an MFP in contention to an idle MFP.

2. The apparatus of claim 1 wherein the contention controller further includes a database of networked MFPs and a user priority list of MFPs for use when contention occurs.

3. The apparatus of claim 1 wherein the contention controller contains a default list of MFPs for use when contention occurs.

4. The apparatus of claim 1 wherein the contention controller resides on one of the more than one MFPs.

5. The apparatus of claim 1 wherein the contention controller resides on and is manipulated by a PC.

6. The apparatus of claim 1 wherein the network is an intranet.

7. The apparatus of claim 1 wherein the network is the Internet.

8. A contention management apparatus in a network of a plurality of MFPs, the apparatus comprising:
(a) an intranet network;
(b) the plurality of MFPs connected to the intranet network; and
(c) a contention controller connected to the plurality of MFPs through a connection to the intranet network, the contention controller including a database of networked MFPs and a user priority list of MFPs for use when contention occurs, wherein the contention controller is configured to direct output from any MFP in contention to an idle MFP on the user priority list.

9. The apparatus of claim 8 wherein the contention controller further includes a default list of MFPs for use when contention occurs.

10. The apparatus of claim 8 further comprising a plurality of MFPs connected to the Internet and to the intranet network.

11. A system for managing contention between more than one MFP connected in a network, the system comprising a contention controller connected to the network, the contention controller configured to identify MFPs in contention and idle MFPs and to direct output to one or more idle MFPs when contention occurs.

12. The system of claim 11 wherein the network comprises an intranet.

13. The system of claim 11 wherein the network comprises the Internet.

14. The system of claim 11 wherein the contention controller further includes a database of networked MFPs and a user priority list of MFPs for use when contention occurs.

15. The system of claim 11 wherein the contention controller further includes a default list of MFPs for use when contention occurs.

16. A method for managing contention in MFPs comprising the steps of:
(a) providing a contention controller;
(b) connecting said contention controller to a network;
(c) connecting a plurality of MFPs to said network;
(d) configuring said contention controller to identify MFPs connected to said network;
(e) configuring said contention controller to identify MFPs in contention and idle MFPs; and
(f) directing output of MFPs in contention to idle MFPs by means of said contention controller.

17. The method of claim 16 wherein the step of connecting to a network further includes the step of connecting to the Internet.

18. The method of claim 16 further comprising the step of adding user preferences to said contention controller for selection of idle MFPs to which output is directed.

19. The method of claim 16 further comprising the step of adding default instructions for selection of idle MFPs to which output is directed.

20. A computer-readable medium having computer-readable instructions thereon which, when executed by a computer, perform the steps of claim 16.
